(19) United States
(12) Patent Application Publication
(10) Pub. No.: US 2021/0241123 A1
(43) Pub. Date: Aug. 5, 2021

(54) OPTIMIZATION DEVICE, OPTIMIZATION METHOD, AND PROGRAM

(71) Applicant: NIPPON TELEGRAPH AND TELEPHONE CORPORATION, Tokyo (JP)

(72) Inventors: Kyota TSUTSUMIDA, Tokyo (JP); Hidetaka ITO, Tokyo (JP); Tatsushi MATSUBAYASHI, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/050,773

(22) PCT Filed: Apr. 24, 2019
(86) PCT No.: PCT/JP2019/017450

§ 371 Date: Oct. 26, 2020

(30) Foreign Application Priority Data
Apr. 27, 2018 (JP) 2018-087589

(51) Int. Cl. G06N 3/12; G06N 20/00; G06N 5/04

(52) U.S. Cl. CPC G06N 3/126; G06N 5/04; G06N 20/00

(57) ABSTRACT

A parameter can be optimized with a small number of evaluations. For each of a plurality of candidate search points that are parameters used as candidates for search points which a candidate search point generation unit 120 has generated based on a plurality of parameters used for calculation, a search point determination unit 130 determines whether or not to set the candidate search point as a search point using a plurality of data points, each including a set of a parameter used for calculation by an evaluation unit 300 and an evaluation value that has been calculated by using the parameter used for calculation by the evaluation unit 300 as a search point.

### TECHNICAL FIELD

The present invention relates to an optimization device, an optimization method, and a program, and more particularly to an optimization device, an optimization method, and a program for optimizing a parameter of machine learning and simulation.

### BACKGROUND ART

The importance of machine learning and simulation has increased in recent years. Examples of a technique using machine learning and simulation include a technique of moving a large number of cars in a simulation to reproduce city traffic (NPL 1). The performance of machine learning varies depending on its hyperparameter. The output of simulation also varies depending on its parameter. Here, the hyperparameter or parameter will be collectively referred to as a parameter.

The parameter needs to be optimized to an appropriate value. This optimization is performed such that an index specified in advance becomes the best by repeating both calculation of an evaluation value for the parameter (hereinafter referred to as evaluation) and search point generation that obtains a parameter used as a candidate for new evaluation (hereinafter referred to as a search point). Methods used for optimization having such a procedure include Bayesian optimization (NPL 2) and a genetic algorithm (NPL 3).

In some cases, there are many parameter items to be optimized and thus a high-dimensional parameter is optimized. In general, the number of evaluations required increases exponentially with the number of dimensions of a parameter. Therefore, the number of accumulated data items (hereinafter referred to as data points), each including a pair of a parameter and an evaluation value, increases as optimization proceeds.

### CITATION LIST

### Non Patent Literature

[NPL 1] Krajzewicz, D., Brockfeld, E., Mikat, J., Ringel, J., Rossel, C., Tuchscheerer, W., Wagner, P., and Wosler, R.: Simulation of modern Traffic Lights Control Systems using the open source Traffic Simulation SUMO, Proceedings of the 3rd Industrial Simulation Conference 2005, pp. 299-302.
[NPL 2] Shahriari, B., Swersky, K., Wang, Z., Adams, R. P., and Freitas, de N.: Taking the human out of the loop: A review of bayesian optimization, Proceedings of the IEEE, Vol. 104, No. 1, 2016, pp. 148-175.
[NPL 3] Papageorgiou, M., Diakaki, C., Dinopoulou, V., Kotsialos, A., and Wang, Y.: Review of road traffic control strategies, Proceedings of the IEEE, Vol. 91, No. 12, 2003, pp. 2043-2067.

### SUMMARY OF THE INVENTION

### Technical Problem

However, the calculation of Bayesian optimization used in the technique of NPL 2 has a problem in that calculation time is significantly increased and processing is not completed in a realistic time if there are a large number of available data points because the number of calculations for obtaining search points is of the order of the cube of the number of data points.

In addition, a computer used may have a memory capacity less than that needed for computation and may fail to perform calculations depending on the configuration and the processing capacity of the computer used.

In the calculation of the genetic algorithm in NPL 3, new search points are acquired through calculation of replacing parameters of known data points on the basis of a given rule called crossover or mutation. Thus, a short calculation time is required to obtain search points, but there is a problem in that good search points are often not acquired and search efficiency is low as compared with Bayesian optimization or the like.

With the foregoing in view, it is an object of the present invention to provide an optimization device, an optimization method, and a program capable which can optimize a parameter with a small number of evaluations.

### Means for Solving the Problem

An optimization device according to the present invention is an optimization device that optimizes a parameter that is used when a calculation is performed with data for use in evaluation as an input, the optimization device including: an evaluation unit configured to calculate an evaluation value that is an index for evaluating a result of the calculation by using the parameter set as a search point and the data for use in evaluation; an optimization unit configured to optimize the parameter; and an output unit configured to output an optimized parameter obtained by repeating processing of the evaluation unit and processing of the optimization unit, wherein the optimization unit includes: an evaluation data storage unit configured to store a plurality of data points, each including a set of a parameter used for calculation by the evaluation unit and the evaluation value that has been calculated by using the parameter used for calculation by the evaluation unit as a search point; a candidate search point generation unit configured to generate a plurality of candidate search points, which are parameters used as candidates for search points, on the basis of a plurality of parameters used for the calculation stored in the evaluation data storage unit; and a search point determination unit configured to determine, for each of the plurality of candidate search points generated by the candidate search point generation unit, whether or not to set the candidate search point as a search point using the plurality of data points stored in the evaluation data storage unit.

An optimization method according to the present invention is an optimization method used for an optimization device that optimizes a parameter that is used when a calculation is performed with data for use in evaluation as an input, the optimization method including: calculating, by an evaluation unit, an evaluation value that is an index for evaluating a result of the calculation by using the parameter set as a search point and the data for use in evaluation; optimizing, by an optimization unit, the parameter; and outputting, by an output unit, an optimized parameter obtained by repeating processing of the evaluation unit and processing of the optimization unit, wherein the optimizing by the optimization unit includes: storing, by an evaluation data storage unit, a plurality of data points, each including a set of a parameter used for calculation by the evaluation unit and the evaluation value that has been calculated by using the parameter used for calculation by the evaluation unit as a search point; generating, by a candidate search point generation unit, a plurality of candidate search points, which are parameters used as candidates for search points, on the basis of a plurality of parameters used for the calculation stored in the evaluation data storage unit; and determining, by a search point determination unit, for each of the plurality of candidate search points generated by the candidate search point generation unit, whether or not to set the candidate search point as a search point using the plurality of data points stored in the evaluation data storage unit.

According to the optimization device and the optimization method of the present invention, the evaluation unit calculates an evaluation value that is an index for evaluating a result of the calculation by using the parameter set as a search point and the data for use in evaluation, the optimization unit optimizes the parameter, and the output unit outputs an optimized parameter obtained by repeating processing of the evaluation unit and processing of the optimization unit.

In the processing by the optimization unit, the evaluation data storage unit stores a plurality of data points, each including a set of a parameter used for calculation by the evaluation unit and the evaluation value that has been calculated by using the parameter used for calculation by the evaluation unit as a search point, the candidate search point generation unit generates a plurality of candidate search points, which are parameters used as candidates for search points, on the basis of a plurality of parameters used for the calculation stored in the evaluation data storage unit, and the search point determination unit determines, for each of the plurality of candidate search points generated by the candidate search point generation unit, whether or not to set the candidate search point as a search point using the plurality of data points stored in the evaluation data storage unit.

A parameter can be optimized with a small number of evaluations because, for each of a plurality of candidate search points, which are parameters used as candidates for search points, generated based on a plurality of parameters used for calculation, determination is made as to whether or not to set the candidate search point as a search point using a plurality of data points, each including a set of a parameter used for calculation by an evaluation unit and an evaluation value that has been calculated by using the parameter used for calculation by the evaluation unit as a search point as described above.

The optimization unit in the optimization device according to the present invention may further include an evaluation environment acquisition unit configured to acquire evaluation environment related information, wherein the evaluation data storage unit is configured to store each of the plurality of data points in association with the evaluation environment related information acquired by the evaluation environment acquisition unit.

The optimizing by the optimization unit in the optimization method according to the present invention may further include acquiring evaluation environment related information by an evaluation environment acquisition unit, wherein the storing by the evaluation data storage unit includes storing each of the plurality of data points in association with the evaluation environment related information acquired by the evaluation environment acquisition unit.

The search point determination unit in the optimization device according to the present invention may be configured to use a discriminator, which has been trained to determine whether or not a good evaluation value is obtained with a combination of the parameter and the evaluation environment related information as an input using the plurality of data points and the plurality of pieces of evaluation environment related information stored in the evaluation data storage unit, and set each of the plurality of candidate search points as a search point if the discriminator determines that a good evaluation value is obtained when a combination of a parameter as the candidate search point and the evaluation environment related information acquired by the evaluation environment acquisition unit has been input to the discriminator.

The optimizing by the optimization unit in the optimization method according to the present invention may further include acquiring evaluation environment related information by an evaluation environment acquisition unit, wherein the storing by the evaluation data storage unit includes storing each of the plurality of data points in association with the evaluation environment related information acquired by the evaluation environment acquisition unit.

The candidate search point generation unit in the optimization device according to the present invention may be configured to generate the plurality of candidate search points by performing sampling from available ranges of elements of the parameter or by using a genetic algorithm for a parameter of each of the plurality of data points stored in the evaluation data storage unit.

A program according to the present invention causes a computer to function as each unit of the optimization device described above.

### Effects of the Invention

According to the optimization device, the optimization method, and the program of the present invention, a parameter can be optimized with a small number of evaluations.

### BRIEF DESCRIPTION OF DRAWINGS

FIG. 1 is a block diagram showing a configuration of a traffic signal control system according to an embodiment of the present invention.

FIG. 2 is an image diagram showing an example of information stored in an evaluation data storage unit according to the embodiment of the present invention.

FIG. 3 is a flowchart showing an optimization processing routine of an optimization device according to the embodiment of the present invention.

FIG. 4 is a diagram showing a relationship between the number of searches and a loss time when the optimization device according to the embodiment of the present invention is used.

### DESCRIPTION OF EMBODIMENTS

Hereinafter, embodiments of the present invention will be described with reference to the drawings.

<Configuration of Traffic Signal Control System According to Embodiment of Present Invention>

The present embodiment will be described with reference to the case where the present invention is applied to an optimization device that uses a traffic condition acquired by a traffic control device as an evaluation environment in traffic signal control and calculates an evaluation value using traffic simulation as means for evaluation to optimize a signal parameter s.

In the present embodiment, traffic signal control is performed by a traffic control device. In traffic signal control, a plan for switching signal light colors is created for one cycle and signal control is performed in accordance with repetitions of the plan. This plan is uniquely determined by specifying a signal parameter s. A process of optimizing the signal parameter s is performed by an optimization device according to the present embodiment.

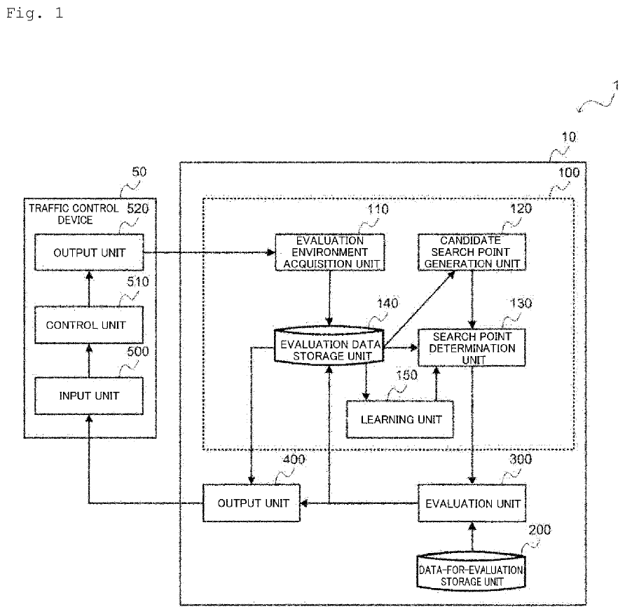

FIG. 1 is a block diagram showing a configuration of a traffic signal control system 1 according to an embodiment of the present invention.

The traffic signal control system 1 according to the present embodiment includes an optimization device 10, a traffic control device 50, and a plurality of traffic signal devices (not shown).

<<Configuration of Optimization Device 10 According to Embodiment of Present Invention>>

The optimization device 10 according to the present embodiment is made of a computer including a CPU, a RAM, and a ROM that stores a program for executing an optimization processing routine that will be described later and is functionally configured as follows.

As shown in FIG. 1, the optimization device 10 according to the embodiment of the present invention includes an optimization unit 100, a data-for-evaluation storage unit 200, an evaluation unit 300, and an output unit 400.

The optimization unit 100 optimizes the signal parameter s.

Specifically, the optimization unit 100 includes an evaluation environment acquisition unit 110, a candidate search point generation unit 120, a search point determination unit 130, an evaluation data storage unit 140, and a learning unit 150.

The evaluation environment acquisition unit 110 acquires the evaluation environment related information.

Specifically, the evaluation environment acquisition unit 110 acquires, from the output unit 520 of the traffic control device 50, evaluation environment information θ that represents a traffic condition such as a congestion condition of a road by a vector. Here, the evaluation environment information θ acquired at a t-th evaluation is represented by evaluation environment information θₜ.

Then, the evaluation environment acquisition unit 110 passes the acquired evaluation environment information θₜ to the evaluation data storage unit 140.

The evaluation data storage unit 140 stores a plurality of data points, each being a set of a signal parameter sₜ used for calculation by the evaluation unit 300 and an evaluation value lₜ calculated using the signal parameter sₜ used for calculation by the evaluation unit 300 as a search point, in association with information regarding the evaluation environment information θₜ acquired by the evaluation environment acquisition unit 110.

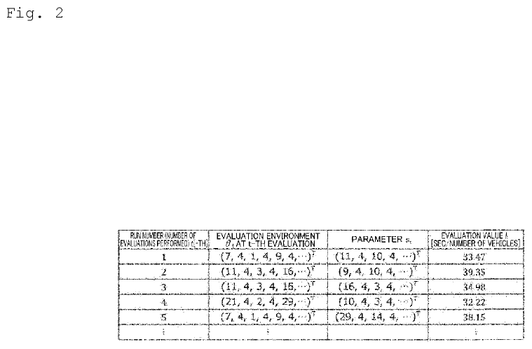

Specifically, the evaluation data storage unit 140 stores the number of evaluations t that the evaluation unit 300 has performed, evaluation environment information θₜ acquired at the t-th evaluation, a signal parameter sₜ which is a vector representing a signal parameter that the evaluation unit 300 has used for calculation at the t-th evaluation, and an evaluation value lₜ that is an evaluation value calculated by the evaluation unit 300 at the t-th evaluation in association with each other as shown in FIG. 2.

Here, the evaluation data storage unit 140 is not limited to being realized with only one table as shown in FIG. 2, but may be realized with a plurality of tables. Further, the evaluation environment column may be omitted in the table when the signal parameter s is optimized for a single piece of evaluation environment information θ.

The candidate search point generation unit 120 generates a plurality of candidate search points, which are signal parameters used as candidates for search points, on the basis of a plurality of signal parameters sₜ used for calculation stored in the evaluation data storage unit 140.

Specifically, the candidate search point generation unit 120 first acquires a plurality of signal parameters sₜ from the evaluation data storage unit 140.

Next, the candidate search point generation unit 120 generates j (for example, 200) signal parameters s used as candidate search points on the basis of the plurality of signal parameters sₜ by performing sampling from available ranges of elements of the signal parameters or by using a genetic algorithm for each signal parameter sₜ of the plurality of data points stored in the evaluation data storage unit 140.

For example, a method of randomly sampling and using values in a uniform distribution from an executable domain S of the signal parameter s can be used when there is no signal parameter stored in the evaluation data storage unit 140 such as in the case of the first optimization process.

The candidate search point generation unit 120 samples signal parameters such as (50, 4, 70, 4) and (150, 4, 33, 4) to generate candidate search points when each element of a signal parameter s is four-dimensional with a blue display and a yellow display in the east-west direction and a blue display and a yellow display in the north-south direction and an available range of the blue display in the east-west direction is 10 to 200 seconds, an available range of the yellow display in the east-west direction is 4 seconds (fixed), an available range of the blue display in the north-south direction is 10 to 200 seconds, and an available range of the yellow display in the north-south direction is 4 seconds (fixed).

The candidate search point generation unit 120 may perform selection, crossover, and mutation operations used in the genetic algorithm to generate candidate search points when the number of signal parameters sₜ stored in the evaluation data storage unit 140 is sufficiently large.

Then, the candidate search point generation unit 120 passes the j generated candidate search points to the search point determination unit 130.

The search point determination unit 130 uses a discriminator c that has been trained to determine whether or not a good evaluation value is obtained with a combination of a signal parameter and evaluation environment information as an input. The search point determination unit 130 sets each of the j candidate search points as a search point if the discriminator c determines that a good evaluation value is obtained when a combination of a signal parameter as the candidate search point and the evaluation environment related information acquired by the evaluation environment acquisition unit 110 has been input to the discriminator c.

Specifically, for each of the j candidate search points, the search point determination unit 130 inputs a concatenation of the signal parameter s as the candidate search point with evaluation environment information θ to the discriminator

c(s,w*)

that has been trained to determine whether or not a good evaluation value is obtained.

The signal parameter s is updated, for example, with a concatenation of the signal parameter s with an r-dimensional vector

θ∈R^{r}

representing the evaluation environment information

s←(sθ)

and then used as a signal parameter

s∈R^{d+r}

to be input to the discriminator c. In this case, w learned by the discriminator c is a d+r-dimensional vector.

The discriminator c receives the signal parameter s as an input and outputs {−1, 1}. The discriminator c determines that a good evaluation value is obtained when the output is 1.

Next, the search point determination unit 130 randomly extracts k signal parameters from the signal parameters s of the candidate search points for which the discriminator c outputs 1, and sets them as k search points.

Then, the search point determination unit 130 passes the k search points to the evaluation unit 300.

The data-for-evaluation storage unit 200 stores data for use in evaluation that is data needed to perform traffic simulations.

Here, the data for use in evaluation may be any data as long as it is data needed to perform traffic simulations. For example, the shapes of roads, the speed limit of each road, the number of vehicles, the entry time of each vehicle into a section for traffic simulation, the route of each vehicle, and the start and end times of traffic simulation can be used as the data for use in evaluation.

The evaluation unit 300 calculates an evaluation value l that is an index for evaluating a calculation result using a signal parameter s set as a search point and data for use in evaluation.

Specifically, the evaluation unit 300 acquires data for use in evaluation from the data-for-evaluation storage unit 200 and calculates an evaluation value l corresponding to the signal parameters of the search point through simulation. The evaluation unit 300 calculates an evaluation value lₜ corresponding to the signal parameter sₜ of the search point through simulation when the calculation of the evaluation value l is a t-th calculation.

Then, the evaluation unit 300 stores a set of the signal parameter sₜ of the search point and the evaluation value lₜ in the evaluation data storage unit 140 as a data point.

The evaluation unit 300 performs the above processing for each of the k search points.

When simulations can be performed in parallel, the evaluation unit 300 may perform parallel evaluation of the k search points output from the search point determination unit 130 with a specified number of parallels to obtain evaluation values l.

Next, the evaluation unit 300 determines whether or not the number of times t the simulation has been performed exceeds a predetermined maximum number of repetitions of simulation (for example, 1,000). If t exceeds the maximum number, the evaluation unit 300 instructs the output unit 400 to output an optimal signal parameter.

On the other hand, if t does not exceed the maximum number, the evaluation unit 300 updates t by adding the number k of search points output by the search point determination unit 130 to t and instructs the optimization unit 100 to perform the processing again.

The output unit 400 outputs an optimized signal parameter s* acquired by repeating the processing of the evaluation unit 300 and the processing of the optimization unit 100.

Specifically, upon receiving an instruction to output the optimal signal parameter s* from the evaluation unit 300, the output unit 400 acquires signal parameters sₜ and evaluation values Iₜ obtained through the traffic simulation up to now which are stored in the evaluation data storage unit 140.

Then, the output unit 400 passes a signal parameter s that minimizes the evaluation value Iₜ to the input unit 500 of the traffic control device 50 as an optimized signal parameter s*.

<<Training of Discriminator c>>

Here, training of the discriminator c by the learning unit 150 will be described.

The learning unit 150 trains the discriminator c, which receives a combination of a signal parameter and evaluation environment information as an input, using information regarding a plurality of pieces of evaluation environment information θₜ and a plurality of data points stored in the evaluation data storage unit 140.

First, the learning unit 150 receives all evaluation environment information and data points from the evaluation data storage unit 140.

Next, the learning unit 150 assigns a label

h∈{−1,1}

to a signal parameter s of each data point according to its evaluation value in order to create a data set D to be learned by the discriminator c.

For example, a label h of 1 is assigned to the top 50 percent of the signal parameters having good evaluation values Iₜ and −1 is assigned to the bottom 50%. These proportions are not limited to 50%. If sufficient data is collected for training of the discriminator c, the proportions may be set freely such as the top 10% and bottom. 20%. The proportions may also be changed during repetition of the optimization processing.

Assuming that a discriminator c that outputs {−1, 1} is a linear discriminator for signal parameters

s∈R^{d+r}

that are d+r-dimensional parameters of positive real numbers, the discriminator c can be expressed as the following expression (1).

$$\begin{matrix}[ Formula 1 ] & \\ c ( s , w ) = \{ \begin{matrix}1 & ( {w}^{T} s > τ ) \\ - 1 & ( otherwise )\end{matrix} & ( 1 )\end{matrix}$$

Here, w is a weight to be learned by the linear discriminator and τ is a predetermined threshold. For example, 0 is used as τ.

Then, the discriminator c learns the weight w such that an error function E (w) of the following expression (2) decreases for the label h given as an output of the discriminator c.

[Formula 2]

E(w)=Σᵢ∥c(sᵢ,w)−hᵢ∥ (2)

Here, i is a variable that has a value of at least 1 and not more than the number of data points (t).

When a stochastic gradient descent method is used for learning the weight w, the weight w is updated as in the following expression (3) using η (0<η<1) representing a learning rate.

$$\begin{matrix}[ Formula 3 ] & \\ w ← w - η \frac{\partial E ( w )}{\partial w} & ( 3 )\end{matrix}$$

The learning ends when the number of updates of the weight w reaches a predetermined upper limit or when the value of the error function E(w) becomes smaller than a predetermined value.

Then, the learning unit 150 obtains a discriminator with the learned weight as w*. The learning unit 150 passes the learned discriminator

c(s,w*)

to the search point determination unit 130.

Note that training of the discriminator c is not limited to the above method, and machine learning methods such as a support vector machine (SVM), a deep neural network (DNN), and a gradient boosting decision tree (GBDT) can be used.

Further, the signal parameter s is updated with a concatenation of the signal parameter s with an r-dimensional vector

θ∈R^{r}

representing the evaluation environment information θ

s←(sθ)

and then used as a signal parameter

s∈R^{d+r}

to be input to the discriminator c. Therefore, an evaluation environment such as a congestion condition can be taken into consideration, good signal parameters can be acquired even at the beginning of search, and search efficiency can be increased.

<<Configuration of Traffic Control Device 50 According to Embodiment of Present Invention>>

The traffic control device 50 is made of a computer including a CPU and a RAM and is functionally configured as follows.

The traffic control device 50 according to the embodiment of the present invention includes the input unit 500 and the control unit 510 as shown in FIG. 1.

The input unit 500 receives an input of an optimized signal parameter s* from the output unit 400. In addition, the input unit 500 receives an input of a traffic condition of an area including a plurality of traffic signal devices as evaluation environment information θ.

Then, the input unit 500 passes the received optimized signal parameter s* and the evaluation environment information θ to the control unit 510.

The control unit 510 controls the traffic signal devices using the evaluation environment information θ and the optimized signal parameter s*.

Specifically, the control unit 510 issues an instruction to each of the traffic signal devices to switch, maintain, blink, and the like its signal light color on the basis of the optimized signal parameter s*.

In addition, the control unit 510 passes, to the output unit 520, evaluation environment information θ indicating a traffic condition after issuing the instruction to each of the traffic signal devices.

The output unit 520 passes the evaluation environment information θ to the evaluation environment acquisition unit 110 of the optimization device 10.

<Operation of Optimization Device According to Embodiment of Present Invention>

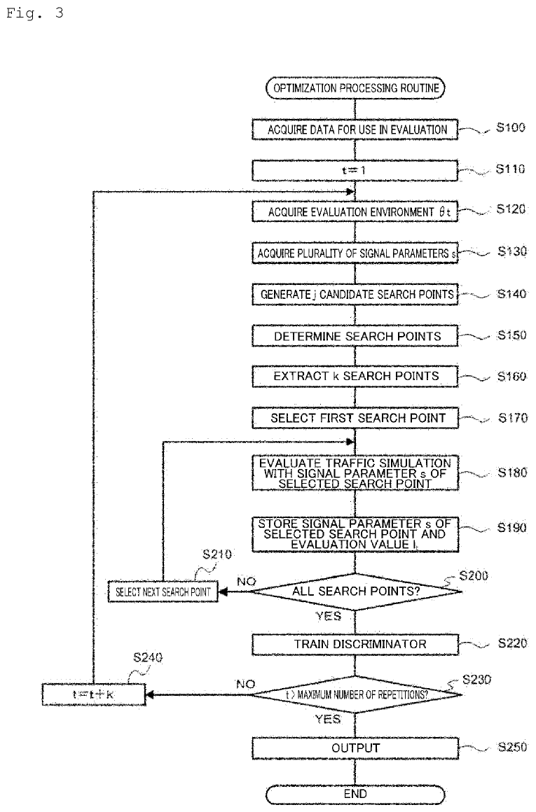

FIG. 3 is a flowchart showing an optimization processing routine according to the embodiment of the present invention.

The optimization device 10 executes the optimization processing routine shown in FIG. 3 when evaluation environment information θ has been input to the evaluation environment acquisition unit 110.

First, the evaluation unit 300 acquires data for use in evaluation from the data-for-evaluation storage unit 200 in step S100.

Next, t is set to 1 such that t=1 in step S110.

In step S120, the evaluation environment acquisition unit 110 acquires evaluation environment information θ, which is evaluation environment related information, from the output unit 520 of the traffic control device 50.

In step S130, the candidate search point generation unit 120 acquires a plurality of signal parameters sₜ from the evaluation data storage unit 140.

In step S140, the candidate search point generation unit 120 generates j candidate search points, which are signal parameters used as candidates for search points, on the basis of the signal parameters sₜ acquired in step S130.

In step S150, the search point determination unit 130 uses a discriminator c, which has been trained to determine whether or not a good evaluation value is obtained with a combination of a signal parameter and evaluation environment information as an input, to determine, for each of the j candidate search points, whether or not a good evaluation value is obtained when a combination of a signal parameter as the candidate search point and the evaluation environment related information acquired by the evaluation environment acquisition unit 110 has been input to the discriminator c.

In step S160, the search point determination unit 130 randomly extracts k candidate search points from candidate search points for which it is determined that a good evaluation value is obtained, and sets them as k search points.

In step S170, the evaluation unit 300 selects the first search point from the k search points.

In step S180, the evaluation unit 300 calculates an evaluation value l that is an index for evaluating a calculation result using a signal parameter s set as the selected search point and the data for use in evaluation.

In step S190, the evaluation unit 300 stores a set of the signal parameter s of the selected search point and the evaluation value l as a data point in the evaluation data storage unit 140.

In step S200, the evaluation unit 300 determines whether or not the above processing has been performed for all search points.

If the processing has not been performed for all search points (NO in step S200), the evaluation unit 300 selects the next search point in step S210 and returns to step S180.

If the processing has been performed for all search points (YES in step S200), the learning unit 150 trains the discriminator c using information regarding a plurality of pieces of evaluation environment information θₜ and a plurality of data points stored in the evaluation data storage unit 140 in step S220.

In step S230, the evaluation unit 300 determines whether or not the number of times t the simulation has been performed exceeds a predetermined maximum number of repetitions of simulation.

If t does not exceed the maximum number (NO in step S230), t+k is substituted for t in step S240 and the processing of steps S120 to S220 is repeated.

On the other hand, if t exceeds the maximum number (YES in step S230), the output unit 400 outputs the optimized signal parameter s* in step S250.

<Experimental Results of Optimization Device According to Embodiment of Present Invention>

Next, results of experiments performed by applying the optimization device 10 according to the present embodiment will be described.

In traffic congestion mitigation task in Luxembourg city, experiments were performed to optimize a signal parameter of about 1500 dimensions for 199 intersections (Reference 1).

[Reference 1] Codeca, L., Frank, R., Faye, S., & Engel, T., “Luxembourg SUMO Traffic (LuST) Scenario: Traffic Demand Evaluation,” IEEE Intelligent Transportation Systems Magazine, 9(2), 2017, p.p. 52-63.

A comparison was made with results when the genetic algorithm (GA) of NPL 3 was used.

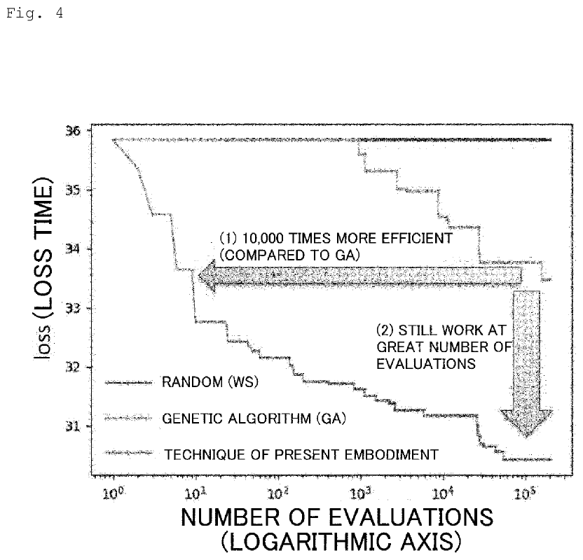

FIG. 4 is a diagram showing a relationship between the number of searches and a loss time when the optimization device 10 according to the embodiment of the present invention is used.

When the method of the present embodiment was used, (1) a search can be made about 10,000 times more efficient compared to the genetic algorithm (GA), and (2) the method can work to obtain a result of improved index even when a great number of evaluations such as 1,000 to 100,000 were performed as shown in FIG. 4.

As described above, the optimization device according to the present embodiment can optimize a parameter with a small number of evaluations by performing determination as described below for each of a plurality of candidate search points, which are parameters used as candidates for search points, generated based on a plurality of parameters used for calculation. The determination is made as to whether or not to set a candidate search point as a search point using a plurality of data points, each including a set of a parameter used for calculation by the evaluation unit and an evaluation value that has been calculated by using the parameter used for calculation by the evaluation unit as a search point.

The present invention is not limited to the above embodiment and various modifications and applications can be made without departing from the gist of the present invention.

The above embodiment has been described with reference to a configuration in which training of the discriminator c is performed during optimization processing of the optimization unit 100. However, training of the discriminator c is not limited to this example and may be implemented as batch processing using data of the evaluation data storage unit 140.

For example, when training of the discriminator c takes time, the optimization device 10 can reduce the processing time of the optimization unit 100 by training the discriminator c in parallel with the processing of the optimization unit 100 and then updating the discriminator c as a model of the search point determination unit 130 when the training is completed or by using a discriminator c that has been trained as batch processing while processing of the optimization unit 100 is not performed.

The present embodiment has been described with reference to the case where a traffic simulation is selected as an evaluation and a signal parameter is selected as a parameter, but the present invention is not limited to this. In another embodiment, the present invention can be applied to, for example, guidance of a crowd using guide staff. In this case, a human flow simulation may be selected as an evaluation and placement location of guide staff and a guidance method may be selected as parameters.

In still another embodiment, the present invention can be applied to optimization of a hyperparameter in machine learning. In this case, training of a machine learning model may be selected as an evaluation and a hyperparameter may be selected as a parameter.

An embodiment in which the program is already installed has been described in the specification of the present application. However, the program may be provided as stored in a computer readable storage unit medium and installed and executed on a computer that is used as an optimization device or may be distributed through a network.

### REFERENCE SIGNS LIST

1 Traffic signal control system
10 Optimization device
50 Traffic control device
100 Optimization unit
110 Evaluation environment acquisition unit
120 Candidate search point generation unit
130 Search point determination unit
140 Evaluation data storage unit
150 Learning unit
200 Data-for-evaluation storage unit
300 Evaluation unit
400 Output unit
500 Input unit
510 Control unit
520 Output unit

1.-8. (canceled)

9. A computer-implemented method for optimizing parameters for control, the method comprising:
receiving evaluation data;
receiving a set of parameters for determining a search point;
determining, based on the evaluation data and the set of parameters, an evaluation value, wherein the evaluation value includes an index for evaluating a result of optimizing the set of parameters;
storing a plurality of data points, wherein each data point includes the set of parameters and the determined evaluation value based on the set of parameters;
generating, based on a plurality of the stored set of parameters in the plurality of data points, a plurality of search point candidates, wherein the plurality of search point candidates represent parameter candidates for the search point;
determining, for each of the generated plurality of search point candidates, whether a search point candidate represents the search point using the stored plurality of data points;
generating, based on iteratively determining the search point and the evaluation value for the search point, an optimized set of parameters; and
providing the optimized set of parameters.

10. The computer-implemented method of claim 9, the method further comprising:
receiving environment information associated with an evaluation environment; and
storing the plurality of data points in combination with the environment information.

11. The computer-implemented method of claim 9, the method further comprising:
determining, using a discriminator, for each of the plurality of search point candidates, the evaluation value, wherein the discriminator is trained to identify the evaluation value based on the stored plurality of data points and the environment information associated with the plurality of evaluation environment, wherein the discriminator uses the set of parameters and the environment information associated with the evaluation environment as input, and wherein the evaluation value is one of positive or negative; and
when the determined evaluation value is positive, determining the search point candidate as the search point.

12. The computer-implemented method of claim 9, the method further comprising:
receiving sampling of data from a domain associated with each element of the set of parameters; and
generating, based on the received sampling of data, the plurality of search point candidates.

13. The computer-implemented method of claim 9, the method further comprising:
generating the plurality of search point candidates using a genetic algorithm.

14. The computer-implemented method of claim 9, wherein the evaluation data relates to traffic information for simulating traffic, wherein the set of parameters relates to controlling at least one traffic signal state, and the environment information of evaluation environment includes a vector representation of a traffic congestion on a road.

15. The computer-implemented method of claim 9, wherein the set of parameters include hyper-parameters for machine learning and parameters for simulation of a flow.

16. A system for optimizing parameters for control, the system comprises:
a processor; and
a memory storing computer-executable instructions that when executed by the processor cause the system to:
receive evaluation data;
receive a set of parameters for determining a search point;
determine, based on the evaluation data and the set of parameters, an evaluation value, wherein the evaluation value includes an index for evaluating a result of optimizing the set of parameters;
store a plurality of data points, wherein each data point includes the set of parameters and the determined evaluation value based on the set of parameters;
generate, based on a plurality of the stored set of parameters in the plurality of data points, a plurality of search point candidates, wherein the plurality of search point candidates represent parameter candidates for the search point;
determine, for each of the generated plurality of search point candidates, whether a search point candidate represents the search point using the stored plurality of data points;
generate, based on iteratively determining the search point and the evaluation value for the search point, an optimized set of parameters; and
provide the optimized set of parameters.

17. The system of claim 16, the computer-executable instructions when executed further causing the system to:
receive environment information associated with an evaluation environment; and
store the plurality of data points in combination with the environment information.

18. The system of claim 16, the computer-executable instructions when executed further causing the system to:
determine, using a discriminator, for each of the plurality of search point candidates, the evaluation value, wherein the discriminator is trained to identify the evaluation value based on the stored plurality of data points and the environment information associated with the plurality of evaluation environment, wherein the discriminator uses the set of parameters and the environment information associated with the evaluation environment as input, and wherein the evaluation value is one of positive or negative; and
when the determined evaluation value is positive, determine the search point candidate as the search point.

19. The system of claim 16, the computer-executable instructions when executed further causing the system to:
receive sampling of data from a domain associated with each element of the set of parameters; and
generate, based on the received sampling of data, the plurality of search point candidates.

20. The system of claim 16, the computer-executable instructions when executed further causing the system to:
generating the plurality of search point candidates using a genetic algorithm.

21. The system of claim 16, wherein the evaluation data relates to traffic information for simulating traffic, wherein the set of parameters relates to controlling at least one traffic signal state, and the environment information of evaluation environment includes a vector representation of a traffic congestion on a road.

22. The system of claim 16, wherein the set of parameters include hyper-parameters for machine learning and parameters for simulation of a flow.

23. A computer-readable non-transitory recording medium storing computer-executable instructions that when executed by a processor cause a computer system to:
receive evaluation data;
receive a set of parameters for determining a search point;
determine, based on the evaluation data and the set of parameters, an evaluation value, wherein the evaluation value includes an index for evaluating a result of optimizing the set of parameters;
store a plurality of data points, wherein each data point includes the set of parameters and the determined evaluation value based on the set of parameters;
generate, based on a plurality of the stored set of parameters in the plurality of data points, a plurality of search point candidates, wherein the plurality of search point candidates represent parameter candidates for the search point;
determine, for each of the generated plurality of search point candidates, whether a search point candidate represents the search point using the stored plurality of data points;
generate, based on iteratively determining the search point and the evaluation value for the search point, an optimized set of parameters; and
provide the optimized set of parameters.

24. The computer-readable non-transitory recording medium of claim 23, the computer-executable instructions when executed further causing the system to:
receive environment information associated with an evaluation environment; and
store the plurality of data points in combination with the environment information.

25. The computer-readable non-transitory recording medium of claim 23, the computer-executable instructions when executed further causing the system to:
determine, using a discriminator, for each of the plurality of search point candidates, the evaluation value, wherein the discriminator is trained to identify the evaluation value based on the stored plurality of data points and the environment information associated with the plurality of evaluation environment, wherein the discriminator uses the set of parameters and the environment information associated with the evaluation environment as input, and wherein the evaluation value is one of positive or negative; and
when the determined evaluation value is positive, determine the search point candidate as the search point.

26. The computer-readable non-transitory recording medium of claim 23, the computer-executable instructions when executed further causing the system to:
receive sampling of data from a domain associated with each element of the set of parameters; and
generate, based on the received sampling of data, the plurality of search point candidates.

27. The computer-readable non-transitory recording medium of claim 23, the computer-executable instructions when executed further causing the system to:
generating the plurality of search point candidates using a genetic algorithm.

28. The computer-readable non-transitory recording medium of claim 23, wherein the evaluation data relates to traffic information for simulating traffic, wherein the set of parameters relates to controlling at least one traffic signal state, and the environment information of evaluation environment includes a vector representation of a traffic congestion on a road.
